(19) United States
(12) Patent Application Publication
(10) Pub. No.: US 2015/0234484 A1
(43) Pub. Date: Aug. 20, 2015

(54) USE OF HYPER GLIDING FOR REDUCING FRICTION BETWEEN AN INPUT DEVICE AND A REFERENCE SURFACE

(71) Applicants: Christophe Rolf Lucien Winter, Yverdon-les-Bains (CH); Yves Perriard, Neuchâtel (CH)

(72) Inventors: Christophe Rolf Lucien Winter, Yverdon-les-Bains (CH); Yves Perriard, Neuchâtel (CH)

(73) Assignee: LOGITECH EUROPE S.A., Morges (CH)

(21) Appl. No.: 14/184,169

(22) Filed: Feb. 19, 2014

(51) Int. Cl. G06F 3/0354; G06F 3/039

(52) U.S. Cl. CPC G06F 3/03543; G06F 3/0395

(57) ABSTRACT

An input device is communicatively coupled to a host, wherein a movement of the input device is measured relative to a reference surface, and wherein the friction between the input device and the said reference surface is dynamically reducible. The input device comprises a housing and an actuator for contacting the reference surface. The actuator comprises a first layer comprising a piezo-electric material to which a voltage is applied and a second layer, comprising a material different than the first layer, bonded to the first layer. The application of voltage to the first layer results in a layer of air being trapped between the actuator and the reference surface. The layer of air reduces the friction from a first amount of friction to a second amount of friction between the input device and the reference surface.

### FIELD OF INVENTION

The disclosure generally relates to input devices and in particular to devices and methods for controlling the friction between an input device and a reference surface.

### BACKGROUND

Over the last few decades, several types of input devices have been developed for generating instructions for computers. These devices include mice, track balls, keyboards and touch pads. Some of those input devices are moved with respect to a reference surface such as a support to generate instructions. These input devices include, for instance, mice. Other input devices are adapted to translate the movement of an object with respect to an active surface of the input device into an instruction for the computer. Those devices include touch pads.

Over time, users have developed certain preferences for using specific input devices for generating specific instructions. For instance, a mouse is specifically adapted to control the movement of a cursor on a computer screen. Touch pads are specifically adapted for allowing a user to link to specific gestures functions such as to leaf through a pile of documents. When using input devices, it should be noted that the friction between the input device and the reference surface on which the input device is used, directly influences the comfort of using the input device and the accuracy of the produced instructions.

For example, for a mouse, this friction has an influence on the movement of the mouse with respect to the reference surface and the effort expended by the user in moving the cursor on the computer screen from one position to another. When using a mouse, the friction reduces both the speed of the user's action as well as the precision of his positioning of the cursor. Further, the friction may result in the production of noise when the mouse is moved over the reference surface. Reducing friction would improve mouse gliding and precision. Further, this would help in reducing or even eliminating slip stick, which is the effect that is caused by the difference between static and dynamic friction. For this and other reasons, reducing and controlling the friction between a mouse and a reference surface can significantly enhance the user's experience.

It should be noted that when using a mouse on a reference surface some friction is needed for comfortable use of the mouse by a user. For instance, a user would not be able to perform the much-used action of double clicking if he was unable to click on the same spot twice. Another example is that when the mouse is not being used, the mouse should not move away from the position where the user had left it due to the lack of friction. This could for instance be the case if the reference surface is inclined.

The level of friction between the input device and the reference surface or support is also important for other types of device, such as touch pads. When using a touch pad, the user will move an object or a finger over or with respect to an active surface of the touch pad. The friction between the touch pad and the reference surface should be sufficient to avoid that the device itself is displaced when moving the finger or the object over the active surface. If the friction is not sufficient, the user could end up using two hands to provide instructions to a computer. One hand would be needed to keep the touch pad at a fixed position while the other hand is used to generate instructions on the active surface of the touch pad.

### SUMMARY

An input device is communicatively coupled to a host, wherein a movement of the input device is measured relative to a reference surface, and wherein the friction between the input device and the said reference surface is dynamically reducible. The input device comprises a housing and an actuator for contacting the reference surface. The actuator comprises a first layer comprising a piezo-electric material to which a voltage is applied and a second layer, comprising a material different than the first layer, bonded to the first layer. The application of voltage to the first layer results in a layer of air being trapped between the actuator and the reference surface. The layer of air reduces the friction from a first amount of friction to a second amount of friction between the input device and the reference surface. The first layer has the form of a disk with an external radius and the second layer has the form of a disk having an external radius which equals or is larger than the external radius of the first layer. The external radius of the second layer is in the interval of 5-8.5 mm.

An input device is communicatively coupled to a host, wherein a movement of the input device is measured relative to a reference surface, wherein the friction between the input device and the said reference surface is dynamically reducible. The input device comprises a housing and an actuator for contacting the reference surface. The actuator comprises a first layer comprising a piezo-electric material to which a voltage is applied and a second layer, comprising a material different than the first layer, bonded to the first layer. The application of voltage to the first layer results in a layer of air being trapped between the actuator and the reference surface. The layer of air reduces the friction from a first amount of friction to a second amount of friction between the input device and the reference surface

### BRIEF DESCRIPTION OF THE DRAWINGS

In the accompanying drawings, structures are illustrated that, together with the detailed description provided below, describe exemplary embodiments. Like elements are identified with the same reference numerals. It should be understood that elements shown as a single component may be replaced with multiple components, and elements shown as multiple components may be replaced with a single component. The drawings are not to scale and the proportion of certain elements may be exaggerated for the purpose of illustration.

FIG. 1 is a three dimensional presentation of an input device in a form of a mouse with three devices for creating a squeeze film between the bottom of the mouse and the reference surface;

FIG. 2 shows a detail of one of the devices according to FIG. 1 for creating a squeeze film;

FIG. 3 shows a side view of the device for producing a squeeze film;

FIGS. 4A and 4B show the movement of a piezo electric element during the expansion and shrinking phase respectively;

FIG. 5 shows a device for producing a squeeze film comprising a stack of piezo electric material;

FIG. 6 shows a graph of air gap plotted against time;

FIG. 7 shows a graph of pressure plotted against time;

FIG. 8 shows a first embodiment in sectional view of a bending leg actuator;

FIG. 9 shows a schematic representation of a mean force created by a squeeze film;

FIG. 10 shows a full disk piezo electric bender actuator;

FIG. 11 shows 1000 random selected actuators which are generated and their locus is represented in the space of experiment;

FIGS. 12, 13, and 14 show three graphs representing the maximal vibration amplitude, the swept volume and the swept surface in function of the computed force;

FIG. 15 represents the optimization process flow charge;

FIG. 16 shows the evolution of the Pareto front in function of the iteration number;

FIG. 17 shows the optimization result for a full piezo electric disk;

FIG. 18 shows the full piezo electric disk correlation function of the Pareto front individuals;

FIG. 19 shows the optimization result for the correlation replaced by the simulated force;

FIG. 20 shows the optimization result for a piezo electric ring element as shown in FIG. 8;

FIG. 21 shows the piezo electric ring element correlation function of the Pareto front individuals;

FIG. 22 shows the optimization result with the correlation replaced by the simulated force;

FIG. 23 represents a third embodiment of a bending actuator having an axisymmetric actuator cross-section;

FIG. 24 shows the optimization result for the piezo electric actuator according to FIG. 23;

FIG. 25 shows the circular piezo electric patch correlation function of the Pareto front individuals;

FIG. 26 shows the optimization results with the correlation replaced by the simulated force;

FIG. 27 represents the comparison of the normalized mean force generated and the normalized correlation assumption;

FIG. 28 shows the correlation function having a wavelength λ≧20 mm;

FIG. 29 shows the correlation function having a wavelength λ≧10 mm;

FIG. 30 represents vibrational topologies;

FIG. 31 shows the correlation functions of the three studied bender topologies;

FIG. 32 shows the optimal Pareto front for the three bender topologies;

FIG. 33 shows the normalized Pareto front of the optimal actuators according to FIGS. 8, 10 and 23; and

FIG. 34 shows in the form of table 1 optimization boundaries.

### DETAILED DESCRIPTION

In the following specification, as used herein, “input device” can include conventional mice, optical mice, touch pads, trackballs, etc. A device and/or method for reducing and controlling friction generated by the movement of an input device on a reference surface can be used with any input devices which need to be moved around continually (e.g., to control cursor movement). Thus while the ensuing discussion focuses on mice, it should be appreciated that the device can be used with other such input devices. Furthermore, “reference surface”, “table”, “surface”, and “work surface” may be used interchangeably, and are considered to include any surface on which the input device may be used, including a mouse pad.

In one embodiment, a device and a method for reducing and controlling friction generated by the movement of an input device on a reference surface, or for reducing and controlling friction generated by a moving part within an input device that controls the generation of instructions is disclosed.

Various embodiments cover solutions that can be used alone or in combination to reduce dynamic and/or static friction. Some embodiments are optimized in combination of materials. That materials lead to better control of the friction between an input device and the reference surface, as well as noise reduction.

In one embodiment, the reduction of friction between the input device and the reference surface is controlled by optimizing the effect of hyper gliding between the input device and the reference surface. Accordingly, a squeeze film is used that prevents the input device from touching the reference surface, even when the user has her/his hand's weight added to the own input device's weight. This is achieved, for instance, by using feet of the input device comprising piezo-electric materials to create oscillations. The applied power to the feet can be altered to dynamically control the amount of friction between the input device and the reference surface.

In some cases, the lifting force decreases sharply when the distance to the table increases, resulting in a small but relatively stable distance to the reference surface.

Another embodiment includes an intelligent algorithm for appropriately controlling friction as required by the circumstances. For instance, when the user desires to double-click at a particular point on the display using the input device, larger friction between the input device and the work surface may be needed. Also, for use in various gaming environments, more or less friction may be desirable.

The features and advantages described herein are not all-inclusive, and particularly, many additional features and advantages will be apparent to one of ordinary skill in the art in view of the drawings, specification, and claims hereof. Moreover, it should be noted that the language used in the specification has been principally selected for readability and instructional purposes, and may not have been selected to delineate or circumscribe the inventive subject matter, resort to the claims being necessary to determine such inventive subject matter.

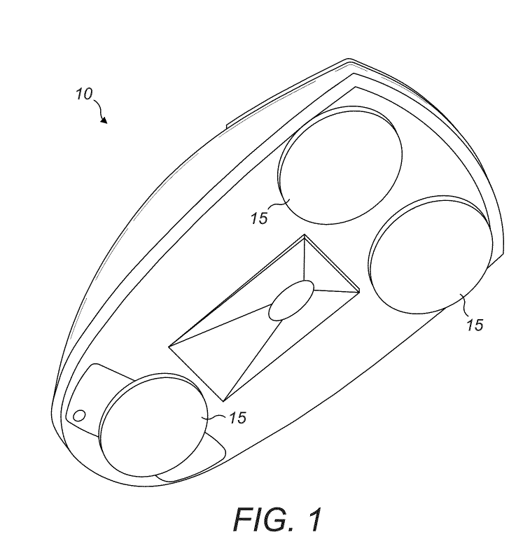

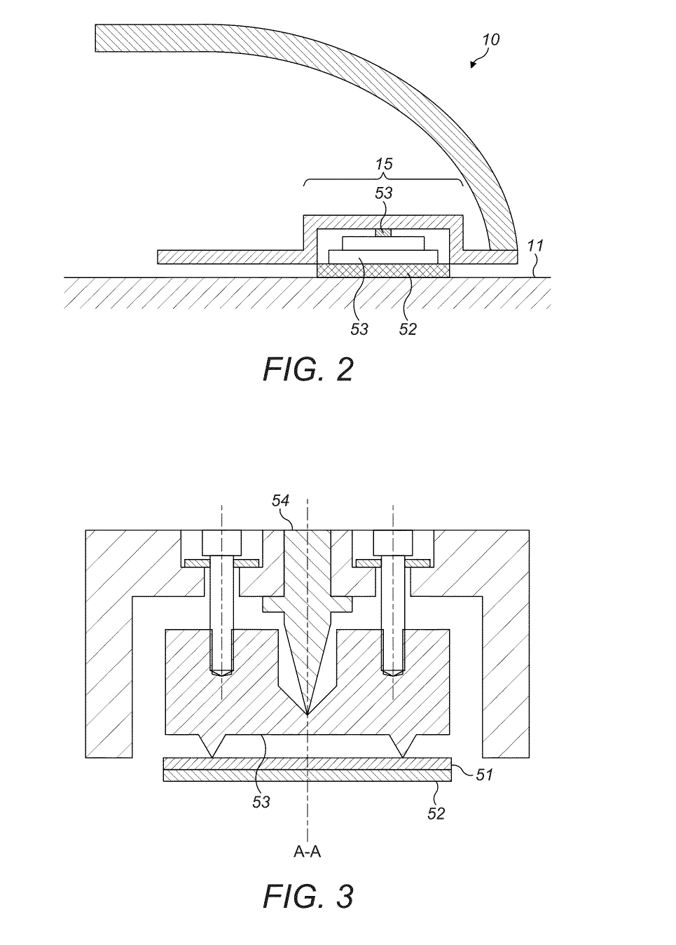

FIG. 2 shows an embodiment wherein ultrasonic squeeze films are used to reduce the friction between an input device 10 such as a mouse 10 as represented on FIG. 1, and the work surface 11. The mouse 10 is provided with three devices (or feet) 15 to create a squeeze film due to vibrations of said devices 15. In one embodiment, such vibrations are perpendicular to the plane of motion of the mouse 10 over the surface 11. The mouse as shown in FIG. 1 has three separate disc shaped feet 15 including a layer made of piezo-electric material. In one embodiment, this piezo-electric layer is bonded to another layer made of a different material. In another embodiment, the feet 15 are made of a stack that vibrates up and down, e.g., a stack of piezo layers. Examples of the piezo electric material which can be used include piezo ceramic material PIC 151, PIC 155, PIC 255. In one embodiment, piezo-polymers can be used instead of piezo-ceramic materials. It is to be noted that other materials which can be stimulated similarly can also be used.

When one or more of these feet 15 are stimulated electrically at the correct frequency, they vibrate and trap a layer of air between them and the work surface 11. The air film appears due to the vibrations and the vibrations are too fast to allow the air to escape through the thin gap. This layer of air significantly reduces friction and the mouse 10 moves around on the work surface 11 with only the slightest touch. The result is comparable to a layer of air created with an air pump.

FIG. 2 shows a partial view of the mouse 10 with one of the feet 15 shown in some detail. In this embodiment, a layer of piezo electric material 51 is bonded to a backing layer 52 made of another material. In this discussion, these layers are referred to as disks, but it is to be noted that these layers may have any shape, e.g., rectangular, elliptical, etc. As shown in FIG. 2, a piezo electric disk 51 is bonded to a backing disk 52 made of another suitable material. In one embodiment, the piezo electric disk 51 is a piezo ceramic disk and the backing disk 52 is made of glass. In another embodiment, the backing disk 52 is made of steel. In a further embodiment, the backing disk 52 comprises an aluminium alloy. In one embodiment, the piezo electric disk 51 and the backing disk 52 are of matching thickness. For example, each of these disks can be 1 mm thick. The piezo electric disk 51 has electrodes deposited onto it. In one embodiment, the electrodes on the piezo electric disks 51 are one on each side. In one embodiment, one wrap-around electrodes is used for single-sided wiring. It will be obvious to one of skill in the art that other oscillation modes and electrode configurations are possible. A piezo-support 53 for supporting the piezo electric disk 51 and the backing disk 52 attached to it can also be seen. A piezo electric driver, not shown, is used to apply a voltage between the electrodes. In one embodiment, to make the piezo layer oscillate, the voltage has to change over time, at the desired oscillation frequency. In one embodiment, Alternating Current (A/C) is used.

FIG. 3 illustrates in further detail the structure of the foot 15. At the bottom, there is the oscillating bonded disk: one layer of piezo ceramic 51 on top and one glass layer 52 on the bottom, glued together. When a voltage is applied between the electrodes, the piezo-ceramic 51 expands or retracts in diameter. The glass 52 being inert, the bonded disk deforms with the centre slightly higher or below the edges and oscillating between these two positions, generally a few microns only. There is a nodal circle that remains fixed but which is able to rotate slightly. This circle is where a support 53 is in contact with the disk, so that it does not dampen the oscillations. The support 53 is placed on a pivot pin 54 so that it can pivot around the tip of the pin and maintain the oscillating bonded disk flat on the reference surface 11 even if there are some irregularities.

FIG. 4 illustrates the functioning of the piezo-electric feet 15. As mentioned above, a piezo electric disk 51 is bonded to a backing disk 52. The two layers 51 and 52 are chosen, in one embodiment, to optimize bending of the joint disk. In one embodiment, the relative thicknesses of the two disks 51 and 52 are adjusted to optimize the deformations.

The piezo ceramic disk 51 is excited at a specific frequency. In one embodiment, the frequency of oscillation is above audible frequencies, so that it cannot be heard. In one embodiment, this frequency is in the order of 20 kHz. When excited, the piezo electric disk 51 expands and shrinks in diameter. The backing disk 52 does not, resulting in a bending of the bonded disk. In an alternate embodiment, two ceramic disks can be bonded together in such a way that when a voltage is applied, one shrinks and the other expands, resulting in increased bending effect. In this case, an additional low friction surface is added underneath in one embodiment. As shown in FIG. 4, this results in dilation and compression of the air under the foot 15. FIG. 4A shows the piezo expansion phase, where FIG. 4B shows the piezo shrinking phase.

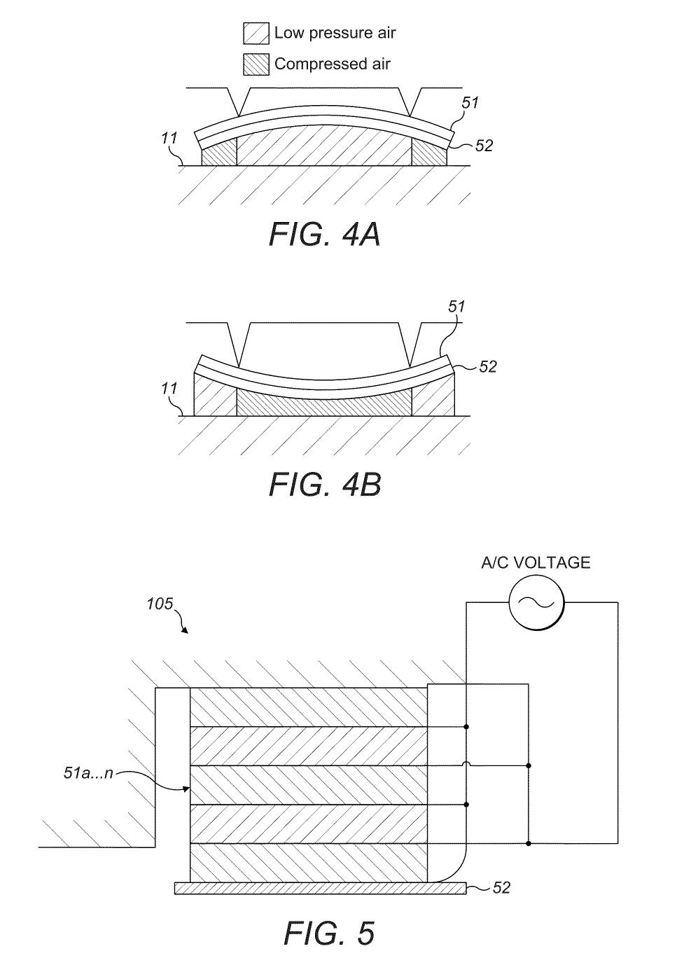

In one embodiment, several layers of piezo-electric elements 51a . . . 51n, as represented in FIG. 5, can be stacked together, instead of a single piezo-electric disk 51, to increase the mechanical movements resulting from an electrical voltage being applied. The stack 51a . . . 51n does not bend as described with reference to FIG. 4 above. Rather, the stack 51a . . . 51n translates up and down with respect to the reference surface 11. If a single thick piezo electric disk 51 is used, the voltage required is very large. Making a stack 51a . . . 51n allows for the layers to be connected in parallel. An example of the thickness of each layer in the stack 51a . . . 51n is about 1 mm. In one embodiment, the electrodes of two adjacent piezo-electric layers are in contact, and the layers are assembled in alternating directions so that they all expand or all contract when a voltage is applied. In one embodiment, the piezo-electric stack 51a . . . 51n is further bonded with the backing disk 52, so that the backing disk 52 protects the fragile electrodes on the piezo elements 51a . . . 51n.

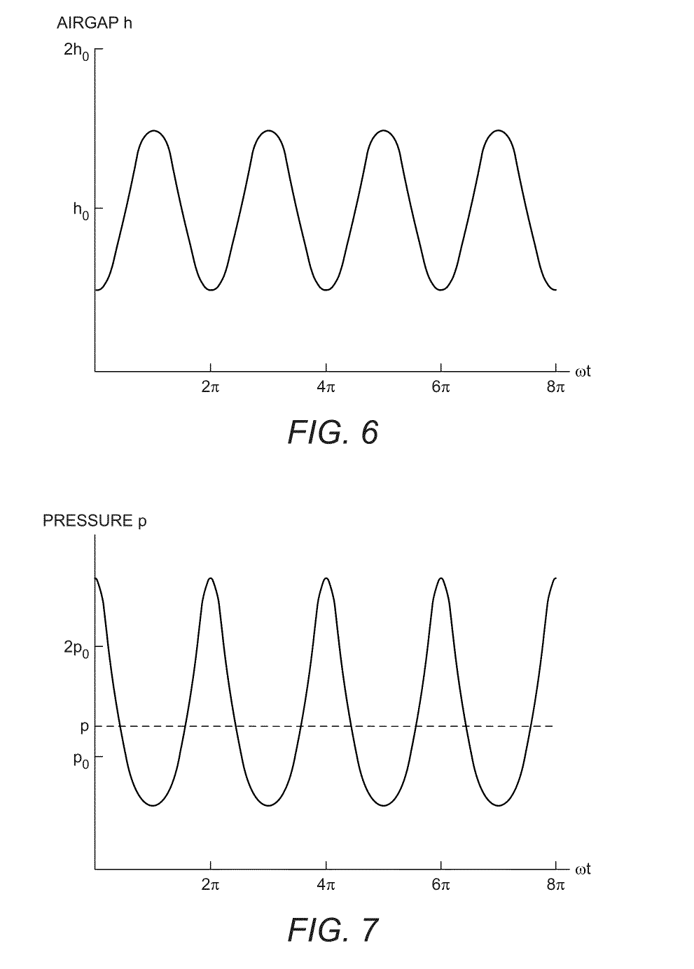

FIGS. 6 and 7 illustrate how the compression and dilation of air under the feet 15 of the mouse 10 illustrated in FIG. 4 results in reduced friction. FIG. 6 illustrates the airgap, i.e the distance between the bonded disk and the work surface 11 plotted against time. FIG. 7 illustrates the pressure built up against time. By comparing FIGS. 6 and 7, it can be seen that a decrease in the height of a portion of the mouse foot, i.e. compression, leads to an increase in pressure, while an increase in the height, i.e. dilation, leads to a decrease in pressure. It is important to note that the relationship between the airgap ‘h’ and the pressure ‘p’ is non-linear. A result of this non-linearity is a lift force.

In one embodiment, the frequency of the driving signal matches one of the resonance frequencies of the assembly in order to maximize the amplitude of oscillation. In one embodiment, the two disks 51 and 52 are attached along their nodal circle so that combined disk can oscillate freely. Such an attachment also allows the full foot assembly to pivot slightly to adapt to the reference surface 11 and sit perfectly flat with even contact pressure. As noted above, materials such as glass, steel or aluminium can be used for the backing disk 52 as long as appropriate bending of the bonded disk is possible. Adjusting the diameter and the thicknesses of the two layers 51 and 52 are also ways to optimize the amplitude of deformation and the frequency of oscillation.

In one embodiment, each foot 15 has a separate oscillator/amplifier circuit tuned to resonance via a trimmer or by an automatic adjustment system. In one embodiment, a low voltage input is used, and an inductor is used to raise the voltage at which the piezo electric disk 51 is stimulated. For example, the input voltage is 24V, while the voltage at which the piezo electric disk 51 is stimulated is 200V.

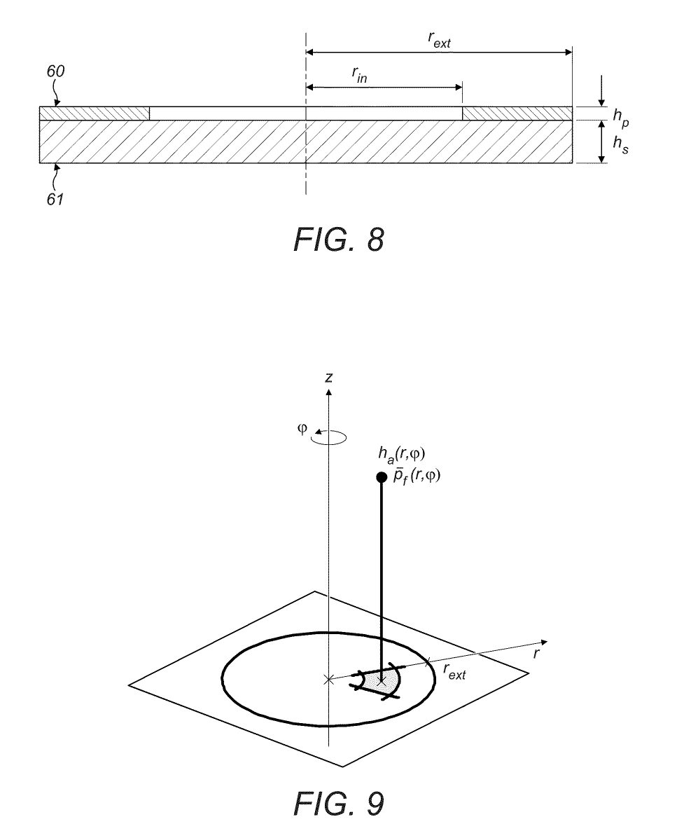

According to another embodiment, the feet 15 comprises bending legs with piezoelectric actuators made of an active annular piezoelectric element 60 glued on a passive support 61. The piezoelectric element 60 is polarised in the axial direction and has electrodes on the two main faces. FIG. 8 shows a sectional view of the used topology. The bimorph effect between the two materials is used to amplify the displacement of the actuator.

Four factors such as the inner and outer diameter, respectively Dᵢₙ=2Rᵢₙ and Dₒᵤₜ=2Rₑₓₜ, and the two thicknesses hₛ and hₚ, are tunable and both the active and the passive materials can be chosen. The factor hₛ refers to the thickness of the backing disk 52; the factor hₚ refers to the thickness of piezo electric disk 51. The glue used to connect both disks is, for instance, an epoxy. This could for instance be Araldite 2011. The contact electrode wires are glued with a conductive epoxy such as EPO-TEK E4110. Both are neglected during the design of the actuator.

In order to properly dimension a feet 15, the conjecture is made that a quantity, evaluated only based on the mechanical vibrational properties of a friction feedback actuator, is correlated to the pressure force generated by the latter. The idea lying behind the correlation conjecture is the possibility to maximize the mechanical value instead of the squeeze film pressure force and still obtain an efficient actuator for friction feedback application thanks to the assumed correlation. This is especially interesting because it is a convenient way to get rid of the time-consuming numerical evaluation of the force produced by the squeeze film effect. That kind of correlation is readily and often implicitly made by choosing to maximize the actuator centre displacement. A circular vibrating surface is used as example to illustrate the purpose.

The mean force F created by the squeeze film effect is a pressure force. In a very general way, it can be expressed, according to FIG. 9 as:

\ddot{F}=∫₀^{2π}∫₀^{r}^{ₑₓₜ}\dot{p}_{f}(r, φ)r dr dφ (1)

It is however known that the overpressure depends on the air film thickness through the Reynolds equation of squeeze film. Therefore the pressure p_{f} is also a function of the air film thickness h and can be rewritten as:

\ddot{F}=∫₀^{2π}∫₀^{r}^{ₑₓₜ} p̅_{f}(h(r, φ, t), r, φ)r dr dφ (2)

with h(r, φ, t)=h₀+hₐ(r, φ)sin(ω₀t). It is important to keep in mind that the pressure function p_{f} is non-linear with the air film thickness h and is not analytic for most of the cases.

Consider now the volume V_{sw} swept by the vibrating surface and defined as:

V_{sw}=∫₀^{2π}∫₀^{r}^{ₑₓₜ}|hₐ(r, φ)|r dr dφ (3)

According to the close form of the two equations describing F and V_{sw} and the relationship between p_{f} and hₐ, a correlation between the force and the swept volume can be expected, which is the first correlation of interest

The second correlation studied is the important influence of the boundary motion. The idea here is to consider the surface swept by the border vibration and is defined as:

S_{sw}=∫₀^{2π}|hₐ(rₑₓₜ, φ)|rₑₓₜdφ (4)

To strengthen the hypothesis of the presented correlations, the particular case of a vibrating surface moving like a piston is studied. The air film thickness is:

h(r, φ, t)=h₀+hᵥ sin(ω₀t) (5)

where hₐ(r, φ, t)=hᵥ and is constant along the vibrating surface. For this particular case, the analytic solution of the mean pressure inside the air film is:

$$\tilde{F} = {p}_{0} \sqrt{\frac{1 + \frac{3}{2} {( \frac{{h}_{v}}{{h}_{0}} )}^{2}}{1 - {( \frac{{h}_{v}}{{h}_{0}} )}^{2}}} - {p}_{0} \qquad ( 6 )$$

Equations (1), (3) and (4) become respectively after integration:

$$\begin{matrix}\tilde{F} = π {r}_{e xt}^{2} ( {p}_{0} \sqrt{\frac{1 + \frac{3}{2} {( \frac{{h}_{v}}{{h}_{0}} )}^{2}}{1 - {( \frac{{h}_{v}}{{h}_{0}} )}^{2}}} - {p}_{0} ) & ( 7 ) \\ {v}_{sw} = π {r}_{ext}^{2} {h}_{v} & ( 8 ) \\ {S}_{sw} = 2 π {r}_{ext} {h}_{v} & ( 9 )\end{matrix}$$

According to physical considerations (hᵥ<h₀ and rₑₓₜ, hᵥ, h₀>0), (7), (8) and (9) are monotone functions. Acting on increasing the swept volume or the swept surface is therefore correlated with the increase of the mean force. The correlation is validated explicitly for this case.

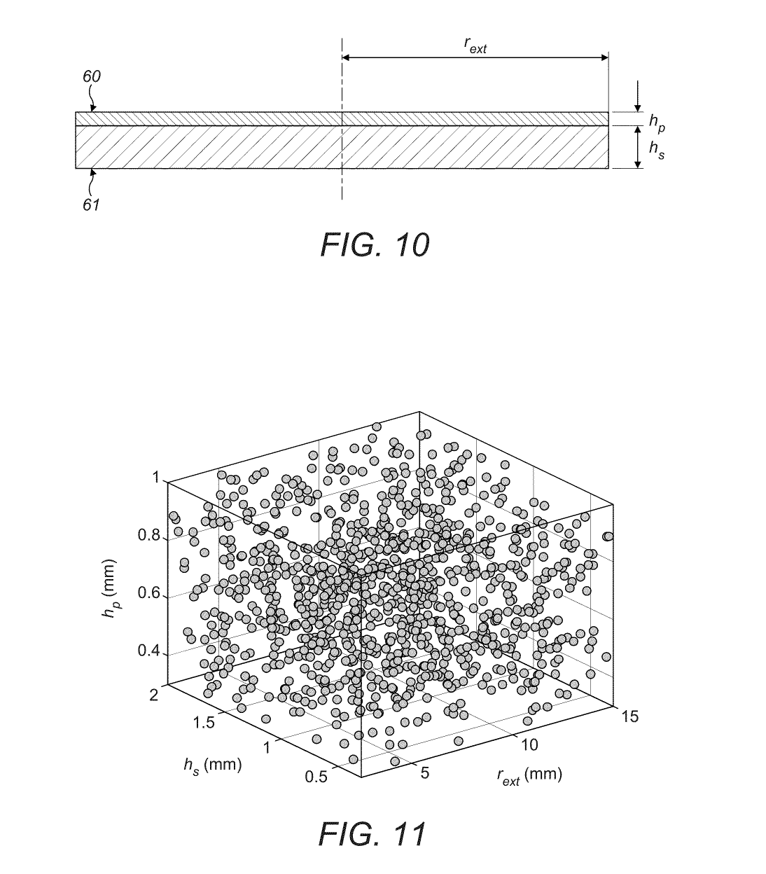

The case of circular piezoelectric benders of various diameters and layers thicknesses is presented in FIG. 10. The resonant frequency and the deformation can be expressed by (10)

$${f}_{ru} = {[ \frac{\partial f ( {\overline{ξ}}_{u} , \overline{θ} )}{\partial {θ}_{i}} ]}_{\overline{θ} = \overline{θ}} . \qquad ( 10 )$$

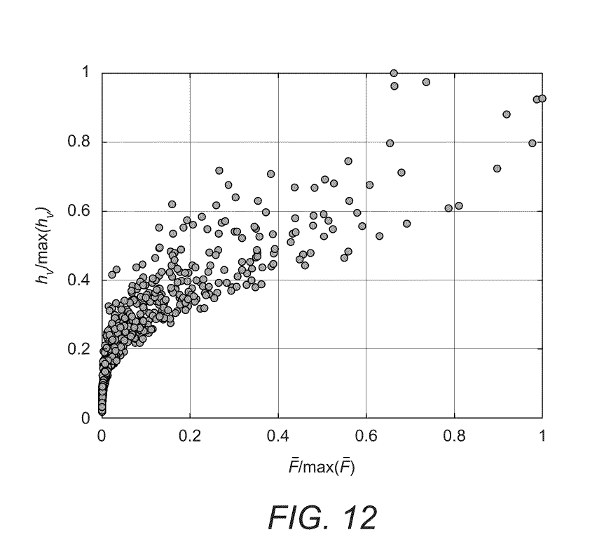

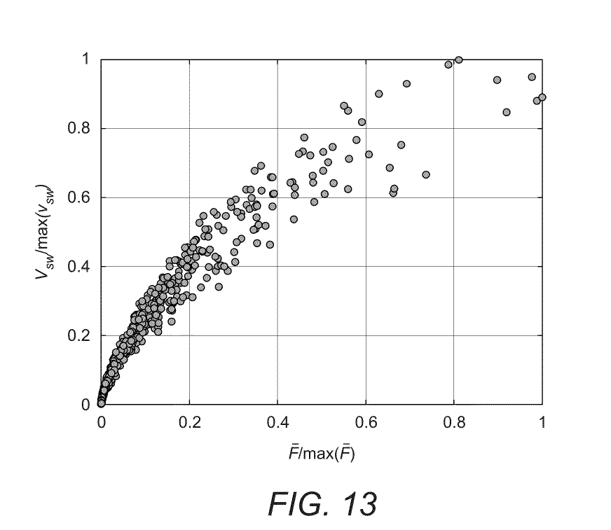

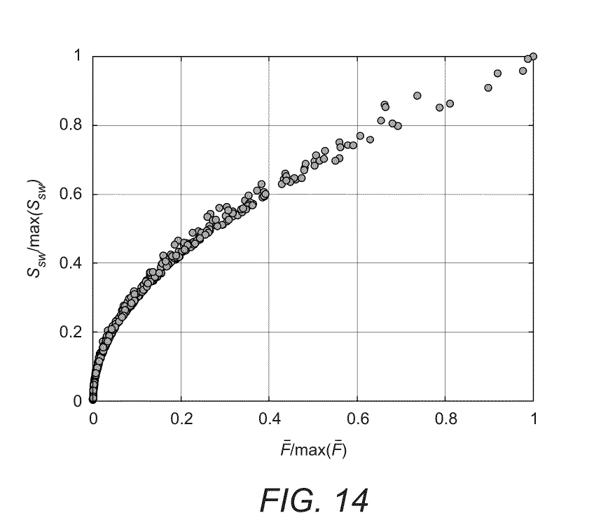

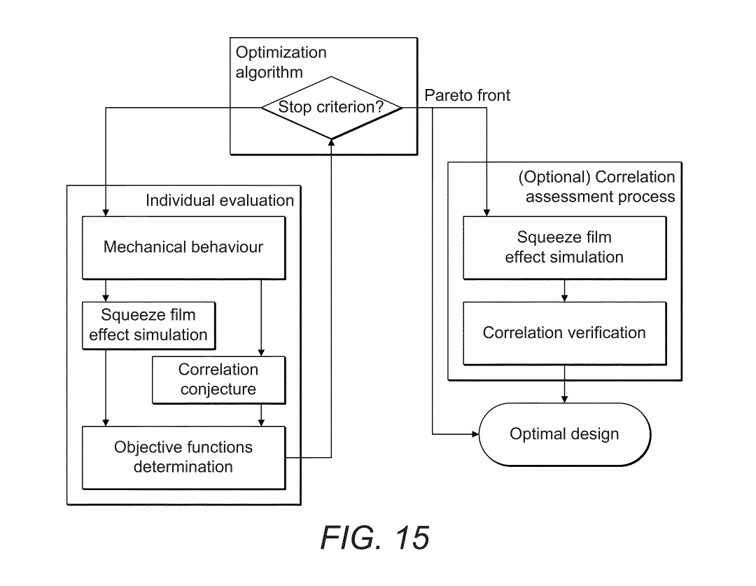

with modified equivalent stiffness D_{G} and poisson's coefficient v_{G}. However, the mechanical behaviour of each actuator is computed numerically in this example. This choice has been made since the Finite Element (FE) model, required to solve the squeeze film effect, has to be programmed and it becomes almost costless to evaluate the Eigen frequency problem once the geometry is entered. One thousand random selected actuators are generated and their locus is presented in the space of experiment shown in FIG. 11. For each actuator, (3), (4), together with the mean force are evaluated. FIGS. 12, 13 and 14 show three graphs presenting the maximal vibration amplitude, the swept volume and the swept surface in function of the computed force. The values are normalized to ease the comparison. From these results, the swept volume shows a better correlation than the maximal vibration amplitude criterion but the best correlated value with the generated force is undoubtedly the swept surface. The correlation conjectures are therefore verified for this case.

It has been shown that the correlation conjecture is interesting to avoid a complete computation of the squeeze film effect phenomenon and still be able to compare two friction feedback actuators. In this work, optimization algorithms are used as tools and are therefore considered as functional black boxes. A tool chain has been set up to perform heuristic optimization using the correlation conjecture and has been implemented in Matlab to be as flexible as possible. The optimization algorithm can be chosen by the designer in function his own skills in optimization problems and, eventually, other available custom algorithms. For sake of broadcasting ease, the Matlab multi-objective GA toolbox, which uses a variant of NSGA-II algorithm, has been used for the following examples and returns a Pareto front as the optimization result. The evaluations of the objective functions are performed with COMSOL Multiphysics and are driven by Matlab scripts. This allows easy modifications of the actuator topology, 2D/3D models or even adds various physics computation. Obviously the evaluation of the objective functions can easily be adapted for each studied case by the user. This leads to FIG. 15 presenting the optimization flowchart followed. The classical approach consisting in computing the pressure force is avoided and the optimization is performed using the correlation assumption. Once the stop criterion is reached, a verification step of the optimization results is added compared to the classical path to evaluate the pressure force generated by the optimal solutions. Typically, the Pareto front properties are expected to stay valid once the objective function is transposed to the pressure force, instead of the swept surface for example, which should strengthen the correlation conjecture. This final assessment step could even be skipped if the correlation conjecture is sufficiently trusted, in order to spare some more computation time.

The following results present the optimization of circular piezoelectric benders aimed to provide friction feedback. Two objective functions are defined: the swept surface S_{sw} and the volume of used piezoelectric material V_{pzt}. The piezoelectric material, which is expensive, needs to be minimized whereas the swept volume needs to be maximized to increase the friction feedback performances. The objective functions are normalized according to a virtual reference actuator with S_{sw}=0.1 mm² and V_{pzt}=100 mm³, during the optimization process. To reduce unwanted audible noise, a working frequency above 20 kHz is required. A penalty function Po is therefore added to the objective functions:

$${P}_{o} = \{ \begin{matrix}1 s \cdot ( 20 kHz - {f}_{0} ) & for {f}_{0} < 20 kHz \\ 0 & for {f}_{0} \geq 20 kHz\end{matrix} \qquad ( 11 )$$

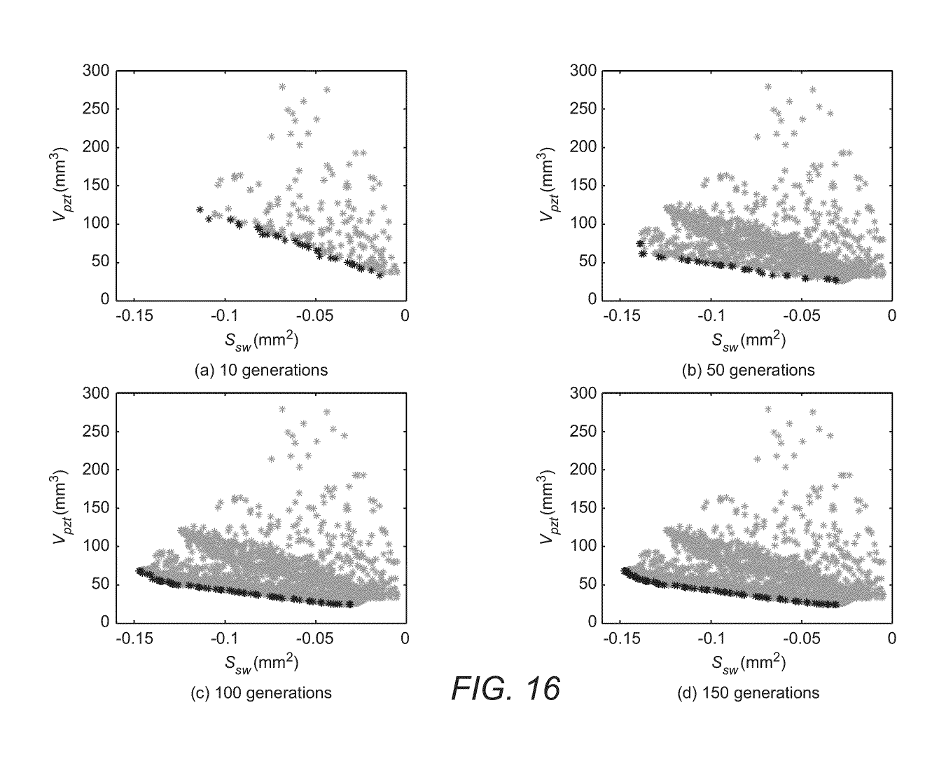

The optimization stop criterion has been set after a maximal number of 500 iterations. The number of individual per generation is set to 30. The algorithm is however stopped manually once the solution is stuck to a local stable state for a sufficient number of iterations as shown in FIG. 16. Three different optimizations are performed considering three different piezoelectric elements: a full piezoelectric disk, a piezoelectric ring and a circular piezoelectric patch. The material properties used for these simulations are for the support layer an aluminium AW-7075 layer and for the piezoelectric element a layer of PZT-5A. It will be shown that all results are coherent with the correlation conjecture.

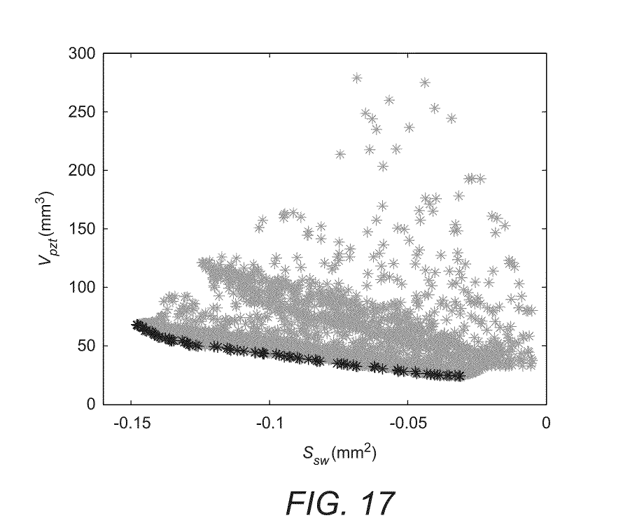

This actuator has already been presented in FIG. 10. The optimization has three free parameters: the external radius rₑₓₜ, the support layer thickness hₛ and the piezoelectric thickness hₚ. The optimization boundaries are given in Table 1 (see FIG. 34). FIG. 16 shows the objective function values for each evaluated individual after, from left to right and top to bottom, 10, 50, 100 and 150 generations. The Pareto front is highlighted in black. It is noticeable that, already after 50 generations, the final optimal Pareto front is almost found. The algorithm is stopped manually after 172 generations and the final result is shown in FIG. 17.

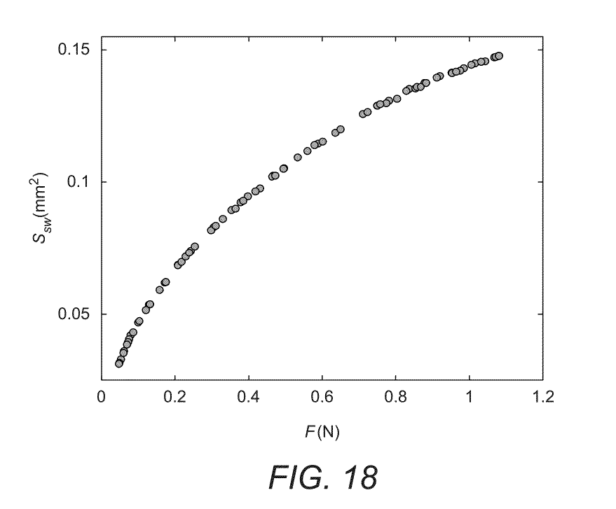

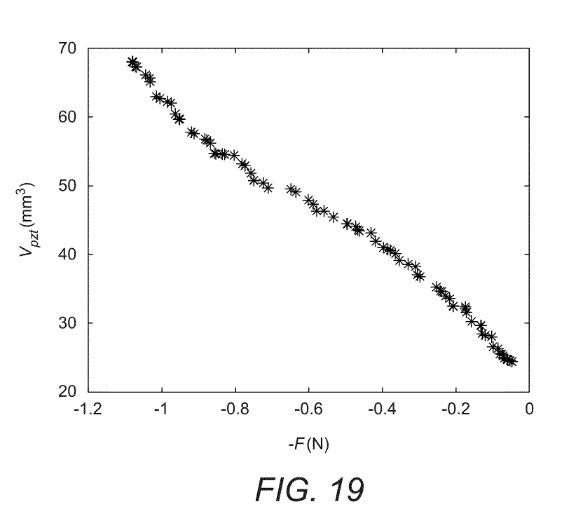

The correlation conjecture is then verified. For each member of the Pareto front, the pressure force is evaluated with a FE simulation and the correlation function is presented in FIG. 18. As expected, the swept surface S_{sw} is well correlated with the force and confirm the formulated hypothesis. FIG. 19 presents another point of view by showing the optimization result, but this time using the computed force instead of the swept surface. As can be seen, the Pareto front definition is still respected. It is interesting to compare the computation time of the optimization process using the correlation conjecture. The objective function has been called 5131 times and the optimization has been done within 2 h 30. To evaluate the same number of actuator but in simulating the squeeze film effect, which each takes about 10 minutes for this actuator topology, the needed time would have been around 36 days. Finally, to perform the verification step of the 83 individuals of the Pareto front, 14 hours have been needed to compute numerically the pressure force. The gain of the method is therefore unquestionable as it can lead to a result obtained in almost 36 times less computation time.

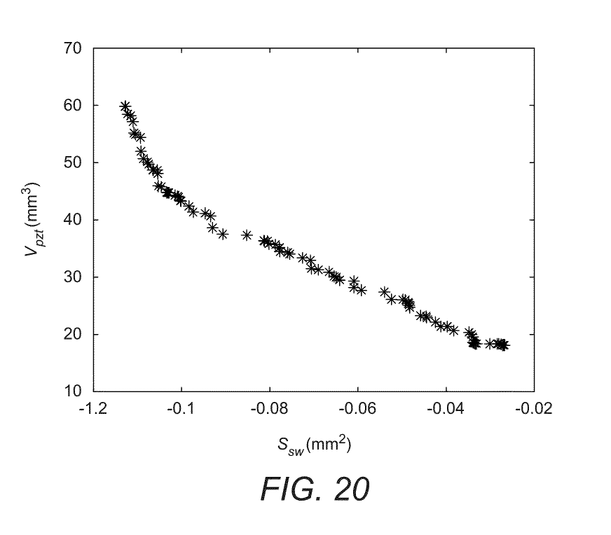

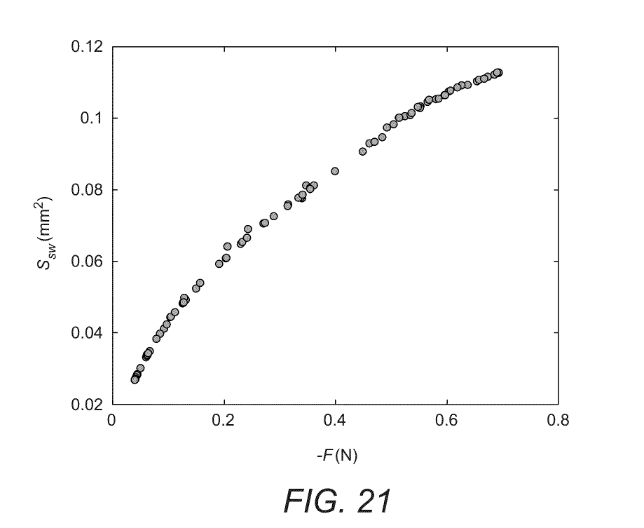

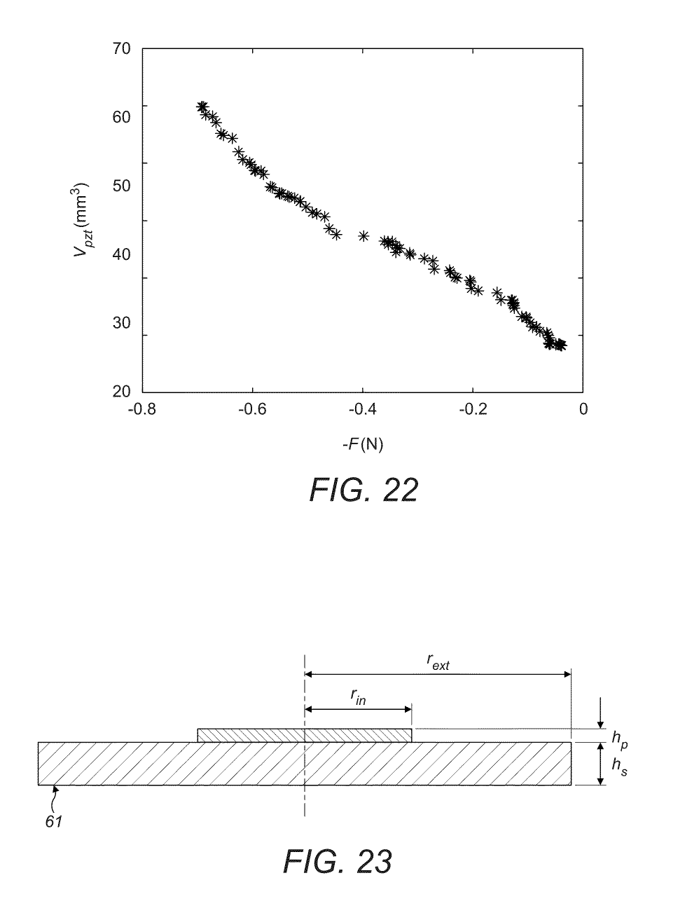

The piezoelectric ring topology is presented in FIG. 8. The optimization has four free parameters: the external radius rₑₓₜ, the ratio between the inner and outer radii rᵢₙ/rₑₓₜ, the support layer thickness hₛ and the piezoelectric thickness hₚ as shown in see Table 1 for the boundaries of optimization. The optimization is performed similarly to the previous actuator and the results are presented in FIGS. 20, 21 and 22 after 336 iterations. As expected, the results confirm the good use of the correlation conjecture criterion. FIG. 21 shows well correlated functions which yield to respect the Pareto front criterion leading from FIG. 20 to FIG. 22.

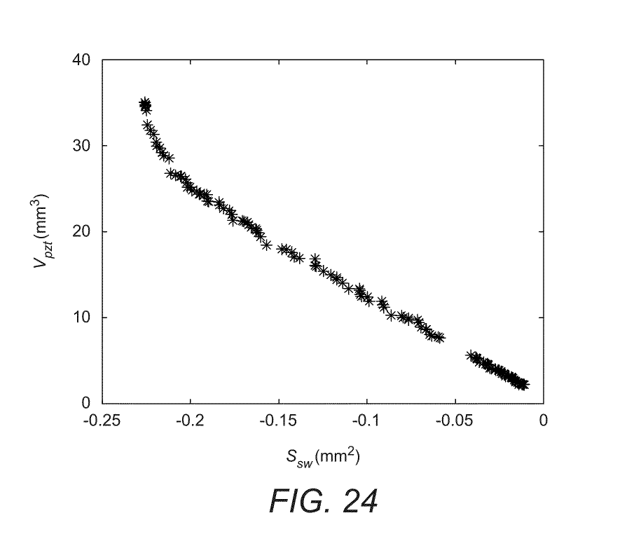

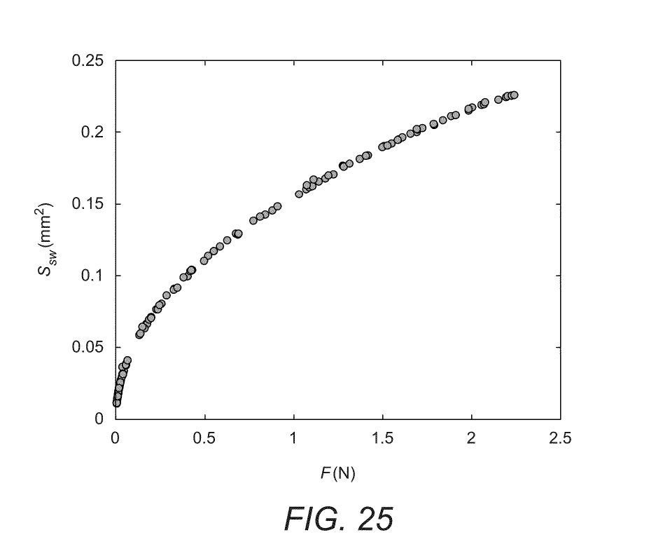

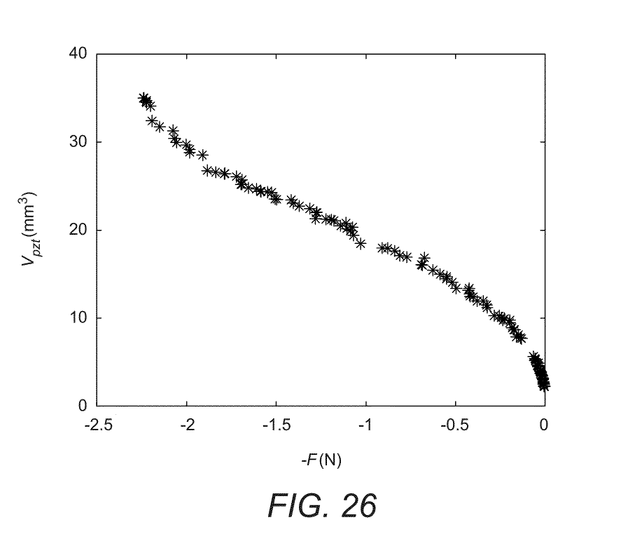

The last presented topology is shown in FIG. 23 and is built with a piezoelectric circular patch. The optimization has also four free parameters: the external radius rₑₓₜ, the ratio between the inner and outer radii rᵢₙ/rₑₓₜ, the support layer thickness hₛ and the piezoelectric thickness hₚ as shown on Table 1 for the boundaries of optimization. The optimization is performed similarly to the two previous actuators and the results are presented in FIGS. 24, 25 and 26 after 335 iterations. From this final example the same conclusions can be drawn and confirms once again the methodology assumptions.

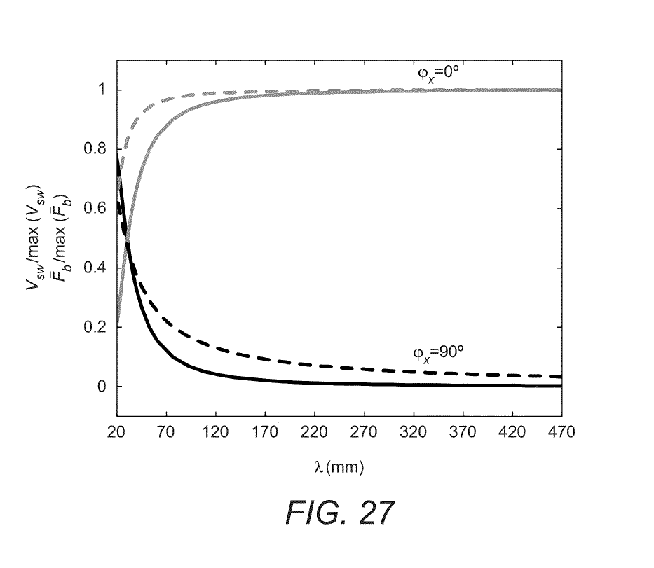

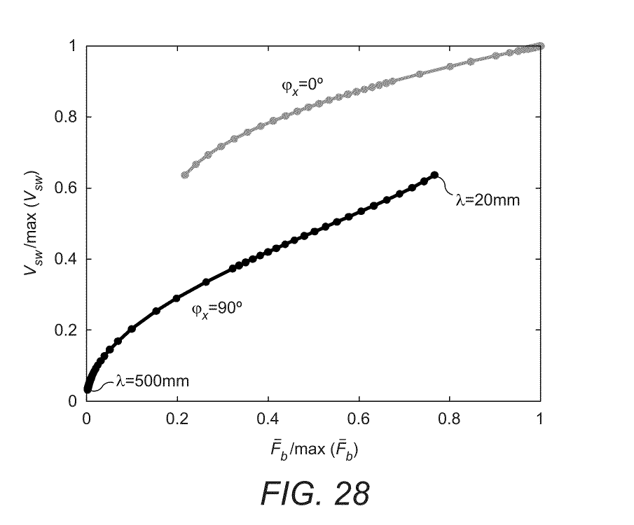

The correlation assumption revealed to be a convenient way to compare the performances of multiple actuators. However, the validity domain of the correlation and its limitations have not yet been discussed. The force homogeneity distribution is a good example to discuss the limitations of the correlation conjecture. FIG. 27 shows, in plain lines, the normalized linear force computed numerically in function of the actuator mechanical wavelength. In dashed lines, the normalized swept volume V_{sw} is computed for each wavelength. The two correlation functions are equal for a wavelength λ=20 mm. The explanation is found by taking a closer look at the correlation functions presented in FIG. 28 for the two mechanical positions øₓ=0° and 90°. The correlation functions are obviously not equals and that is the reason explaining why they cannot be compared one to the other. However the correlation conjecture is verified for each position separately. It leads to the conclusion that the correlation function is dependent of what could be called the vibrational topology and that the conjecture is valid only within the same vibrational topology.

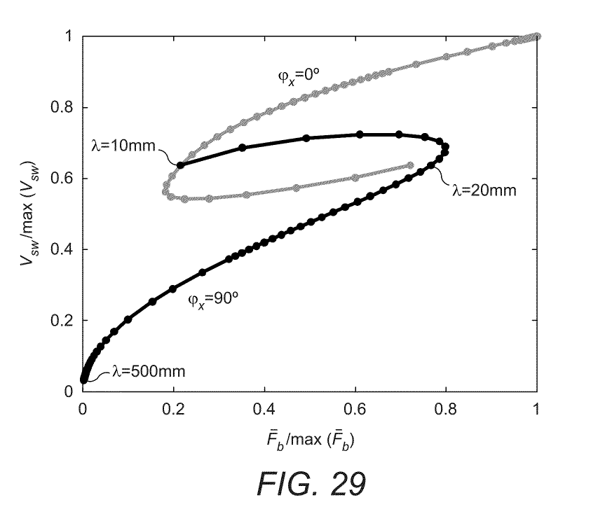

To strengthen this conclusion, the correlation functions can be evaluated for smaller wavelengths. It leads to FIG. 29 highlighting that the correlation functions are even no more bijective which is absolutely not compatible with the previously presented method of optimization. Once again, this can be related to the vibrational topology, remembering that in this example the length of the floating surface is l₀=10 mm. It means that the correlation conjecture is valid per part, each part corresponding to a particular vibrational topology.

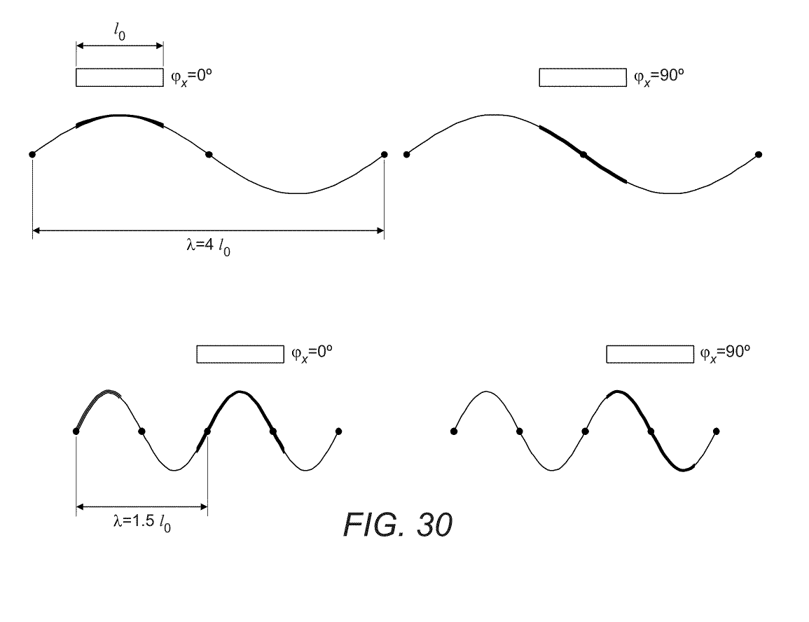

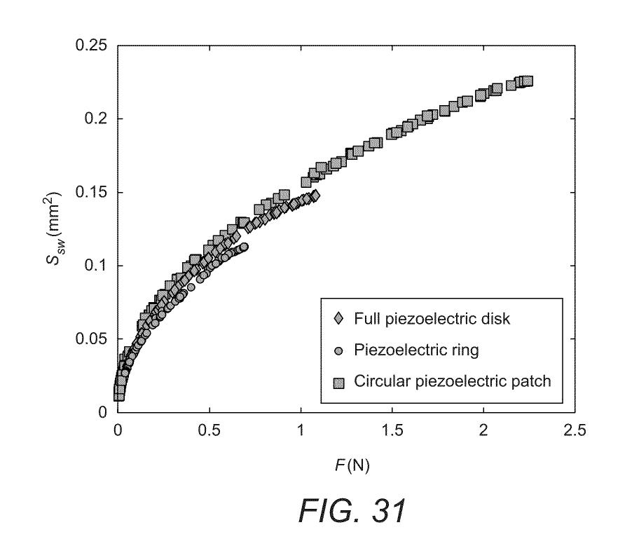

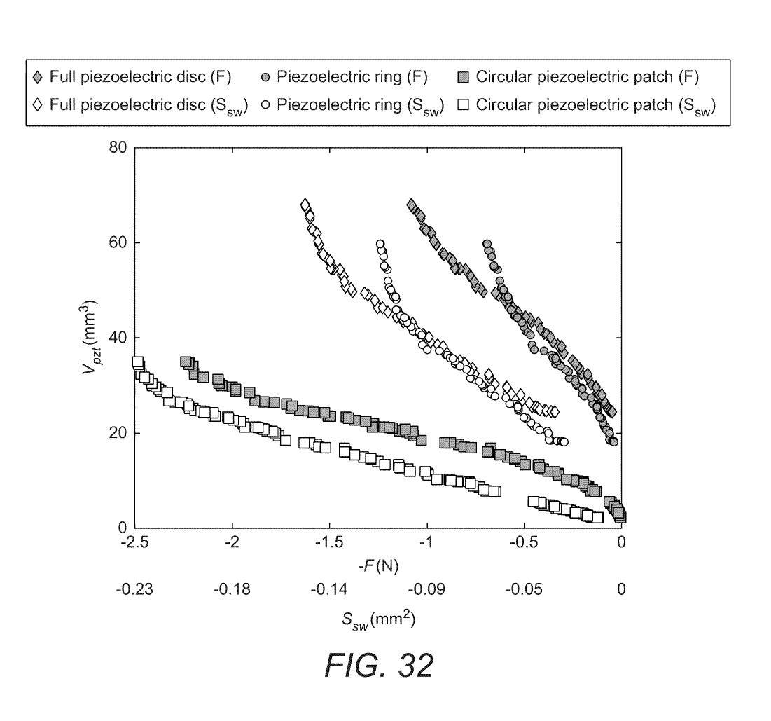

FIG. 30 helps to clarify the notion of vibrational topology by presenting four different cases which are four different vibrational topologies. The node and antinode positions and numbers create four virtual friction feedback actuators with four independent correlation functions that cannot be compared. They are called Virtual as multiple vibrational topologies can be present on the same physical actuator depending on the position and its vibrational modes. Thus, to compare correctly two actuators they need to have the same kind of mechanical displacement. This is the case for the three actuators topologies presented above. They have very similar correlation functions, as shown in FIG. 31 allowing to compare their friction feedback capabilities, i.e. the Pareto front obtained for each optimization, using the correlation conjecture. This is verified in FIG. 32 showing the Pareto front of the correlation conjecture and of the simulated pressure force.

Based on the considerations above and the results presented in the drawings with respect to optimization of the mouse feet and referring to FIGS. 8, 10 and 23, it is possible to conclude that:

The possible ranges of each of the activators are:

Rin<8 mm

hₛ<1 mm,

hₚ<1 mm

hₚ could, for instance, be within the interval of 0.3-0.4 mm

In case a full piezo disk is used, as shown in FIG. 10, the following parameters appear to allow optimization of the mouse feet hₛ and hₚ.

Rext=[5; 8.5] mm

hₛ=[0.3; 0.6] mm

hₚ=[0.3; 0.35] m

In case a piezo ring is used, as shown in FIG. 8, the following parameters can be used:

Rext=[5; 8.5] mm

Rin=[2; 3.5] mm

hₛ=[0.3; 0.6] mm

hₚ=[0.3; 0.35] mm

In case a circular patch is used, as shown in FIG. 23, the following parameters appear to allow optimization:

Rext=[5; 8.5] mm

Rin=[1.5; 6] mm

hₛ=[0.3; 0.5] mm

hₚ=[0.3; 0.4] mm

It appears that the embodiment, as shown in FIG. 23 allows optimization of the design of a mouse foot. For this specific use of hyper gliding in an input device, the possible ranges for the activators, as presented above, allow optimization of the squeeze film generated by means of the mouse feet and allow cost effective production of the mouse feet, in view of the relatively high cost of the piezo electric disk.

Below, a further example will be given of a possible embodiment of an activator to be used as a mouse foot.

### EXAMPLE I

To produce functional demonstrators, an available piezoelectric element from Noliac's catalogue, such as RING OD20ID12TH0.5-NCE51, has been chosen a priori according to its mechanical dimensions to be compatible with a computer mouse size. The choice of the passive support material has been inspired by other vibrating actuators. Copper beryllium alloy (CuBe) and aluminium alloy (EN AW-7075) are therefore considered.

The available prototypes showed the capability to produce a squeeze film effect. However their topology is chosen arbitrarily due to available piezoelectric element. In this section the question of the optimal topology and the optimal design of actuator are therefore addressed.

The optimization process is performed on the three topologies (a)-(c) as shown in FIGS. 8, 10 and 23. Two objective functions are evaluated. The first one aims to maximize the swept volume V_{sw}. Equation (12) is used to compute V_{sw} for each individual. The second objective function aims to minimize the volume of piezoelectric material V_{pzt} used. It is computed for topologies (a)-(c) respectively as:

V_{sw}=∫₀^{2π}∫₀^{r}^{ₑₓₜ}|w(r, φ)|r dr dφ. (12)

V_{pzt(a)}=πhₚr²ₑₓₜ

V_{pzt(b)}=πhₚ(r²ₑₓₜ−r²ᵢₙ)

V_{pzt(c)}=πhₚr²ᵢₙ

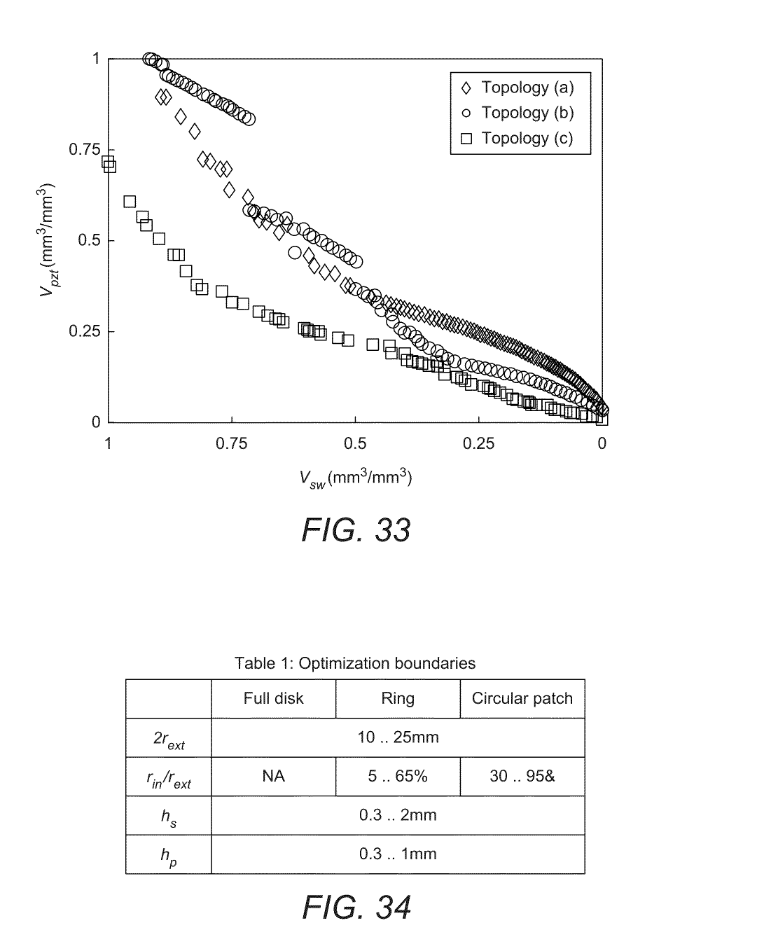

Moreover, to avoid audible noise, a constraint on the resonant frequency f₀=20 kHz is set. The optimization results are presented in FIG. 33. The Pareto front in the space of the two objective functions is plotted for each topology and can be compared. Based on FIG. 33, topology (c) as shown in FIG. 23 is the more interesting to obtain a high swept volume V_{sw} with the less piezoelectric material. It is therefore an interesting topology for industrial production to reduce material costs. However, the two other topologies can still achieve swept volume values in a similar range.

The main tendencies revealed by the optimization show that to increase V_{sw}, the outer diameter of the actuator should be big which leads to a greater piezoelectric material needs. On the other hand, to reduce the piezoelectric volume, one needs to reduce the outer diameter of the actuator sacrificing therefore the swept volume. For all topologies, the thickness of the piezoelectric material should be the thinnest.

What is claimed is:

1. An input device communicatively coupled to a host, wherein a movement of the input device is measured relative to a reference surface, wherein the friction between the input device and the said reference surface is dynamically reducible, the input device comprising:
a housing; and
an actuator for contacting the reference surface, the actuator comprising:
a first layer comprising a piezo-electric material to which a voltage is applied; and
a second layer, comprising a material different than the first layer, bonded to the first layer;
wherein application of voltage to the first layer results in a layer of air being trapped between the actuator and the reference surface, wherein the layer of air reduces the friction from a first amount of friction to a second amount of friction between the input device and the reference surface; and
wherein the first layer has the form of a disk with an external radius and the second layer has the form of a disk having an external radius which equals or is larger than the external radius of the first layer, wherein the external radius of the second layer is in the interval of 5-8.5 mm.

2. The input device of claim 1, wherein the first layer has a thickness of 0.3-0.4 mm and wherein the second layer has a thickness of 0.3-0.6 mm.

3. The input device of claim 1, wherein the first layer has a form of a disk with corresponding outer radius as the second layer, and wherein the thickness of the first layer is in the interval of 0.3-0.35 mm.

4. The input device of claim 1, wherein the first layer has the form of a ring having an outer radius corresponding to the external radius of the second layer and having an internal diameter of 2-3.5 mm.

5. The input device of claim 4, wherein the first layer has the thickness of 0.3-0.35 mm.

6. The input device of claim 1, wherein the first layer has the form of a disk with an external radius smaller than the second external radius of the second layer, wherein the external radius of the first layer is in the interval of 1.5-6 mm.

7. The input device of claim 6, wherein the thickness of the second layer is in the interval of 0.3-0.5 mm.

8. The input device of claim 1, wherein the second layer comprises glass.

9. The input device of claim 1, wherein the second layer comprises steel.

10. The input device of claim 1, wherein the second layer comprises an aluminum alloy.

11. An input device communicatively coupled to a host, wherein a movement of the input device is measured relative to a reference surface, wherein the friction between the input device and the said reference surface is dynamically reducible, the input device comprising:
a housing; and
an actuator for contacting the reference surface, the actuator comprising;
a first layer comprising a piezo-electric material to which a voltage is applied; and
a second layer, comprising a material different than the first layer, bonded to the first layer,
wherein the application of voltage to the first layer results in a layer of air being trapped between the actuator and the reference surface, wherein the layer of air reduces the friction from a first amount of friction to a second amount of friction between the input device and the reference surface.
